(19) United States
(12) Patent Application Publication
(10) Pub. No.: US 2018/0370611 A1
(43) Pub. Date: Dec. 27, 2018

(54) REAR PRESSURE BULKHEAD WITH COMPOSITE-GEOMETRY INTEGRAL MEMBRANE

(71) Applicant: AIRBUS OPERATIONS (S.A.S.), Toulouse (FR)

(72) Inventors: Bernard GUERING, Montrabe (FR); Laurent SAINT-MARC, Montaigut Sur Save (FR)

(21) Appl. No.: 16/015,409

(22) Filed: Jun. 22, 2018

(30) Foreign Application Priority Data
Jun. 23, 2017 (FR) 1755742

(51) Int. Cl. B64C 1/10; B64C 1/06; B64C 1/18

(52) U.S. Cl. CPC B64C 1/10; B64C 1/068; B64C 1/00; B64C 1/18; B64C 1/061

(57) ABSTRACT

A rear pressure bulkhead for aircraft with a semi-recessed integrated engine or, for aircraft of which the cross section of the tail cone in the region of the pressure bulkhead is of the ovoid type with inwardly curving side walls is provided. The cross section of the tail cone of such aircraft is atypical and subjected to loadings that make the application of a known shape of pressure bulkhead unsuitable. The integral membrane of which the geometric shape includes the combination of two substantially spherical half-caps and of a portion of a cylinder of substantially circular cross section joining the two half-caps, the free edges of the cylinder portion being slightly inwardly curved. Such a geometry allows the pressure bulkhead to withstand the loadings present in this zone.

### CROSS REFERENCE TO RELATED APPLICATION

This application claims priority to and incorporates by reference French Patent Application Number 1755742 filed Jun. 23, 2017.

### BACKGROUND

### 1. Field of the Invention

The present invention relates to rear pressurization bulkheads for aircraft with integrated rear propulsion of the semi-recessed type and, more specifically to rear pressurization bulkheads for aircraft in which the tail cone cross section in the region of the pressure bulkhead is of the ovoid type with inwardly curving side walls.

### 2. Description of the Related Art

A pressurization bulkhead in an aircraft, referred to as a pressure bulkhead, is an airtight and strong transverse wall separating a pressurized zone from a non-pressurized zone. The rear pressure bulkhead is situated in the region of the rear part of an aircraft, between a pressurized space accessible to individuals and which may notably comprise the passenger cabin, and a non-pressurized rear zone. In the flight phase, the pressure bulkhead needs to be able to withstand a pressure differential between the two zones.

In aircraft with integrated rear propulsion of the semi-recessed type, two jet engines are installed on the sides of the fuselage partially recessed into the fuselage of the aircraft. That results in a highly specific shape at the rear of the fuselage as depicted in FIGS. 1 to 3. As seen in those figures, the fuselage narrows in a direction transverse to the length of the aircraft more significantly than it does in the direction of the tapering of the height in order to leave space free on the sides of the fuselage for installing and supplying the engines. The tail cone of the aircraft takes the shape of a laterally compressed cone. More specifically, the cross section of the fuselage tail cone as depicted in FIG. 3 has the shape of two semicircles connected by two straight-line segments. In order to ensure optimal engine installation, the straight-line segments have a curvature that causes them to converge inwardly toward one another slightly in the central part. In this way, the lateral walls of the fuselage may conform to the contours of the engines. The specific geometry of the cross section will be referred to here as “ovoid with inwardly curved side walls”. The present invention applies to aircraft with integrated rear propulsion of the semi-recessed type but may also be applied to any aircraft of which the cross section of the tail cone 12 in the region of the pressure bulkhead is of the ovoid type with inwardly curved side walls.

In view of this atypical shape of the ovoid type with inwardly curved side walls, the usual shapes of pressure bulkhead are unsuitable and exhibit unsatisfactory pressure resistance or rather increased complexity and mass.

For example, Patent Application FR2953193 filed on Nov. 30, 2009 by AIRBUS OPERATIONS SAS discloses a possible shape of pressure bulkhead in the form of a flexible membrane associated with at least two rigid supports discontinuously. This shape has the advantage that it can adapt to any fuselage profile by altering the lengths of the supports but has the disadvantage of a complex architecture and a mass that is not optimal given the number of supports required in addition to the membrane itself.

### SUMMARY

The present disclosure is embodied as a pressure bulkhead of a shape optimized for the atypical cross section of an aircraft with integrated rear propulsion of the semi-recessed type.

The present disclosure is further embodied as a rear pressure bulkhead for an aircraft of which the cross section of the tail cone in the region of the pressure bulkhead is of the ovoid type with inwardly curving side walls, wherein the pressure bulkhead comprises an integral membrane of which the geometric shape comprises the combination of two substantially spherical half-caps and of a portion of a cylinder of substantially circular cross section joining the two half-caps, the free edges of the cylinder portion being slightly inwardly curved.

In an exemplary embodiment of the pressure bulkhead, one of the circular-arc edges of each half-cap is joined to the corresponding circular-arc edge of the cylinder portion and the other free circular-arc edge of each half-cap is used with the free edge of the cylinder portion for attaching the membrane to the aircraft.

The present disclosure is also embodied as an aircraft comprising a pressure bulkhead exhibiting the features set out hereinabove, of which the cross section of the tail cone in the region of the pressure bulkhead is of the ovoid type with inwardly curved side walls, wherein the tail cone of the fuselage comprises a frame in the region of which the membrane is incorporated, of which the shape exhibits evolutive inertia.

In an exemplary embodiment, the height of the web of the frame is a height that is greater in the region of the lateral curve segments facing the edge of the membrane in the region of the cylinder portion than in the region of the upper and lower semicircular portions thereof.

The frame may include appendages or attachment points (protrusions) arranged on either side thereof, on one and the same transverse line in the region of the lateral curve segments facing the edge of the membrane in the region of the cylinder portion.

The membrane is fixed to a ring section itself fixed both to the fuselage and to the frame.

A transverse beam connects the lateral curve segments of the frame.

The transverse beam is a transverse floor beam.

The transverse beam may connect together two points of the frame that have the greatest inertia on each side of the longitudinal plane P of symmetry.

The transverse beam may connect the appendages or the protrusions.

### BRIEF DESCRIPTION OF THE DRAWINGS

For an understanding of embodiments of the disclosure, reference is now made to the following description taken in conjunction with the accompanying drawings, in which:

FIG. 1 depicts an exploded perspective view of three portions of the nose cone, the cabin, and the tail cone of the fuselage of a double-decker aircraft with integrated rear propulsion of the semi-recessed type,

FIG. 2 depicts a top view of the fuselage of FIG. 1 with the three portions assembled;

FIG. 3 depicts a simplified cross section view of the overall shape of the fuselage taken along the line A-A of FIG. 2, where the pressure bulkhead is situated;

FIG. 4 depicts a simplified and exploded perspective view of an exemplary pressure bulkhead showing the geometric shape of the three parts;

FIG. 5 depicts a perspective view of the precise shape of the pressure bulkhead according to FIG. 4;

FIG. 6 depicts a side view of the pressure bulkhead according to FIG. 5;

FIG. 7 depicts a cross sectional view of the fuselage with the floors and the pressure bulkhead in the region of the cross section depicted in FIG. 3;

FIG. 8 depicts the same cross sectional view according to FIG. 7 of the fuselage, without the floors and the pressure bulkhead;

FIG. 9 depicts a simplified enlarged perspective view of the region at which the exemplary embodiment pressure bulkhead is fixed to the fuselage by means of a frame and of a ring section; and,

FIG. 10 depicts a perspective view of the pressure bulkhead in accordance with an exemplary embodiment.

In the accompanying drawings, like reference characters refer to the same or similar parts throughout the different views. The drawings are not necessarily to scale, emphasis instead being placed upon illustrating particular principles, discussed below.

### DETAILED DESCRIPTION OF SOME EMBODIMENT

Some embodiments will be now described with reference to the Figures.

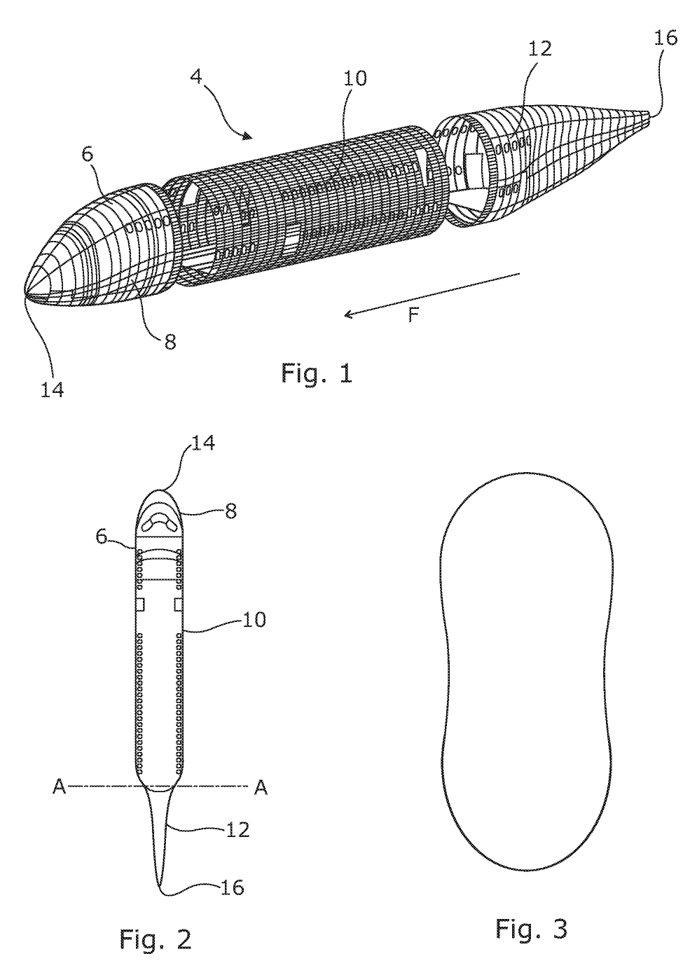

As shown in FIGS. 1 to 6, the present disclosure is related to a new shape of rear pressurized bulkhead 2 referred to as the pressure bulkhead for aircraft 4 with integrated rear propulsion of the semi-recessed type.

As illustrated in FIGS. 1 to 3, the fuselage 6 of the aircraft 4 comprises three parts: a front part 8 commonly referred to as the nose cone, a central part 10, the cross section of which has a constant geometry, comprising the cabin and which for the sake of simplicity will be referred to in the remainder of the description as the cabin, and a rear part 12 commonly referred to as the tail cone or rear cone. The terms front and rear are used with reference to the direction of travel of the aircraft in flight as indicated by the arrow F in FIG. 1. The cross section of the nose cone 8 and of the tail cone 12 decreases progressively from the cross section of the cabin 10 to the respectively front 14 and rear 16 end of the aircraft.

The pressure bulkhead 2 is arranged in the tail cone 12, namely in the rear narrowing zone.

As best seen in FIGS. 1 and 2, the tail cone 12 has the overall shape of a cone that has been compressed laterally. The compression may be from a press the lateral platens of which include mutually-facing curved surfaces with very small convex curvature: the fuselage cross section depicted in FIG. 3 in the region of the location of the pressure bulkhead in the tail cone, namely in the region of the plane A-A in FIG. 2, takes the form of two semicircles connected by two curved segments very close to straight-line segments, the concavity of the curvatures of the segments facing outward. Stated somewhat differently, the cross section of the fuselage in the tail cone region taken along line A-A may have a peanut shape and configuration. This specific geometry of the cross section is referred to as “ovoid with inwardly curved side walls”. The present disclosure applies to aircraft with integrated rear propulsion of the semi-recessed type but also applies to any aircraft of which the cross section of the tail cone 12 in the region of the pressure bulkhead is of the ovoid type with inwardly curved side walls.

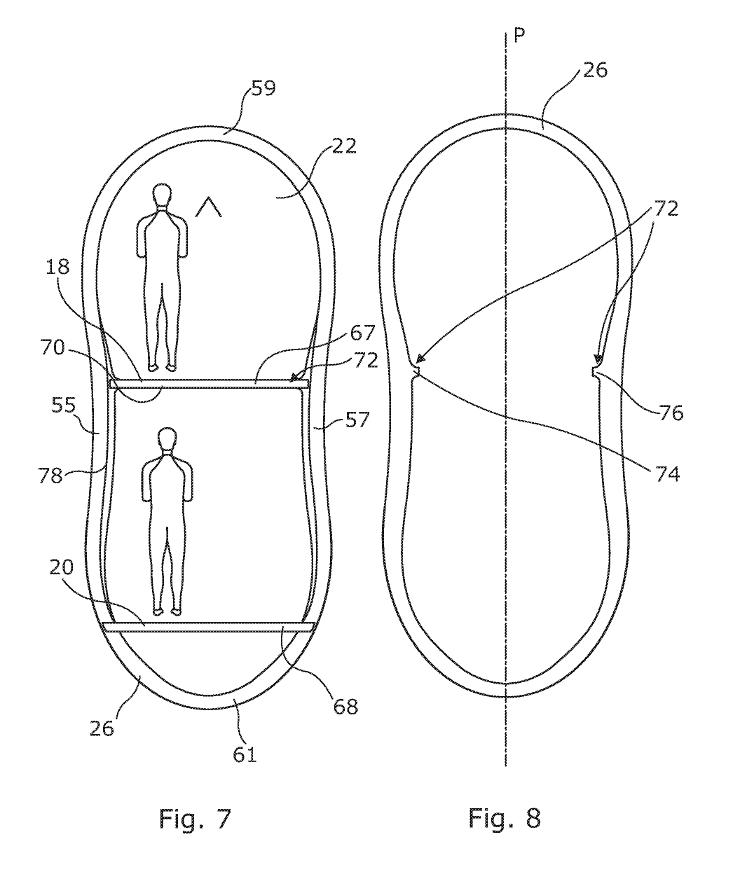

In the embodiment illustrated, the aircraft is a double-decker aircraft, namely having an upper deck 18 and a lower deck 20 (which are visible in FIG. 7), but the present disclosure may also be utilized in a single-deck aircraft.

In order to reduce the time taken to assemble the aircraft 4, increasingly integral modules are being used. An integral module groups independent structures and/or systems together into a single physical entity that can be moved around and installed in the aircraft in one piece and in a single operation. The floor may, for example, form part of an integral module including part of the structure (beams, transverse beams, etc.) but also systems (electrical wiring harnesses, ducting of all kinds, etc.). In order to counter the loads present near the pressure bulkhead, structural connections between the pressure bulkhead and the floor may be provided. Also, in the case of an integral module notably comprising the floor, this type of connection could be envisaged. However, such structural connections require substantial time during the assembly and especially so given their highly specific nature resulting from the unconventional shape of the fuselage.

Furthermore, referring to FIG. 2 and the location of the pressure bulkhead 2 taken along line A-A, the pressure bulkhead 2 needs to be able to withstand a pressure differential between the pressurized zone of the cabin 10 and the non-pressurized zone of the tail cone 12. The very particular shape of the cross section of the fuselage 6 where the pressure bulkhead is attached (in the region of the plane A-A) implies that if the desired end-result is an embodiment that is optimal in terms of complexity and mass, then a novel design of pressure bulkhead that takes account of the very high loadings in this zone needs to be found.

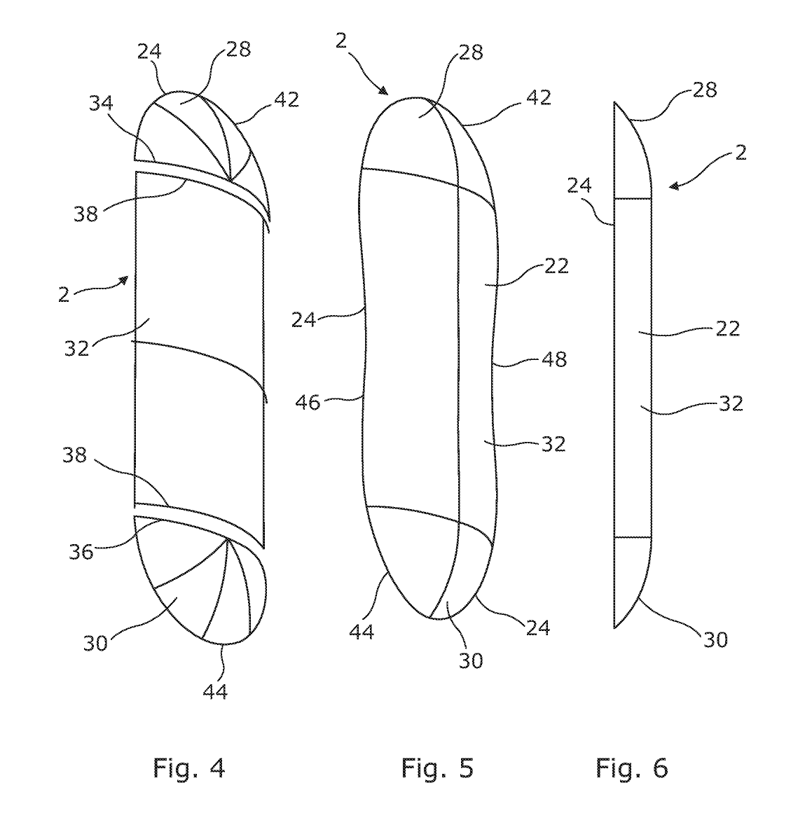

As illustrated in FIGS. 4 to 10, the pressure bulkhead 2 comprises an integral membrane 22 having a free edge along which is assembled to the fuselage and more particularly to a frame 26 of the fuselage. The term “integral” means that the membrane is of one single piece, that can be moved around as one. The membrane 22 could, according to one possible form of embodiment, also be made as a single piece.

The membrane 22 has a surface that is not planar but concave, the concavity facing toward the cabin 10. The pressure bulkhead 2 reacts the loads generated by the pressure differential and transfers them to the fuselage 6.

In order to withstand the pressure differential, the geometric shape of the membrane 22 is optimized as a result of having a combination of elementary geometries recognized as being stable with regard to pressure. Thus, as depicted in FIGS. 4 to 6, the membrane 22 has the shape of two substantially spherical half-caps 28, 30 spaced apart and connected to one another by a portion 32, which is in a form of a partial cylinder having a substantially circular cross section. A spherical cap refers in the present application to a portion of a sphere bounded by two parallel planes a distance d apart, one of them tangential to the sphere, the distance d being less than or equal to the radius of the sphere. The distance d could be equal to the radius in which case the spherical cap corresponds to a hemisphere and therefore the half-cap to a quarter of a sphere. The cylinder portion in the present application refers, just like the sphere portion, to a portion of a cylinder of substantially circular cross section bounded by two parallel planes a distance e apart, one of which is tangential to the cylinder, the distance e being less than or equal to the radius of the base of the cylinder. The distance e could be equal to the radius of the base in which case the cylinder portion corresponds to a half-cylinder. The substantially spherical half-cap 28 includes an arcuate peripheral edge 34, and the substantially spherical half-cap 30 includes an arcuate peripheral edge 36. The upper half-cap 28 is attached along the arcuate peripheral edge 34 to a corresponding arcuate peripheral edge 38 of the cylinder portion 32, and the lower half-cap 30 is attached along the arcuate peripheral edge 36 to an opposing corresponding peripheral edge 38 of the cylinder portion 32.

Because of this geometry, the integral membrane 22 is made up of two substantially circular arcs, an upper arc 42 and a lower arc 44 (in the region of the substantially spherical upper 28 and lower 30 half-caps) connected by and extending along the two opposing side curve segments 46, 48 substantially close to the straight-line segments and corresponding to the side elongated peripheral edge 24 of the cylinder portion 32, in which the slight concavity of the curvatures of the segments are facing outward. The radius of curvature of the curve segments 46 and 48 is greater than that of the upper arc 42 and the lower arc 44. Thus, the free edge 24 of the membrane follows the contours of the atypical shape of the cross section of the fuselage 6.

The partially spherical and partially cylindrical shapes are recognized as being shapes that are stable with regard to pressure. The membrane 22 is thus the result of a combination of stable shapes and allows an integral membrane to be installed despite the loads resulting from the shape of the highly specific zone in question.

The small amount of inflection of the curve segments 46 and 48 of the membrane leads to a shape which is not exactly a portion of a cylinder and therefore does not locally behave exactly in the same way as a portion of a cylinder. However, because of the very slight nature of this inflection, it can be compensated for by adjusting the thickness of material of the membrane in this zone in order to guarantee a behavior of the type exhibited by something partially cylindrical with a substantially circular cross section.

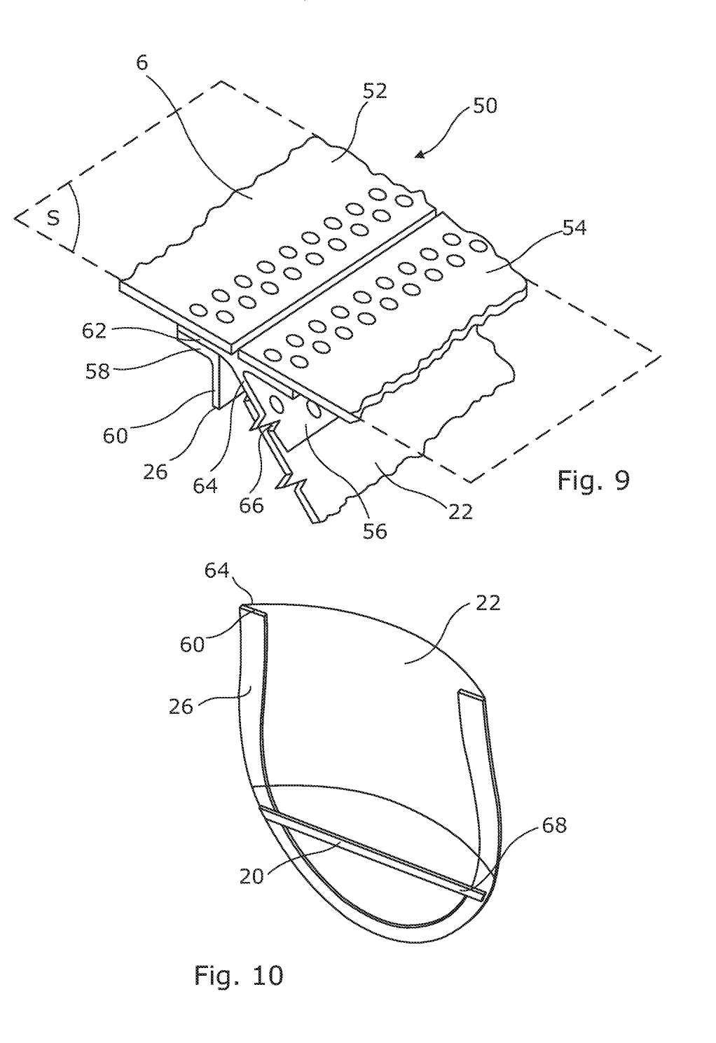

Referring now to FIG. 9, the pressure bulkhead 2 connects to a fuselage frame 26 via a connection device 50. The frame 26 is situated at the meeting of two panels 52, 54 of fuselage sections. The panels 52 and 54 of the sections are connected to one another using a ring section 56 to which the frame 26 is fixed. In the embodiment illustrated, the frame 26 comprises a flange 58 and a web 60 perpendicular to flange 58. The ring section 56 comprises a flange 62 and a body 64. The body 64 makes an angle of less than 90 degrees with the flange 62 so as to form a surface 66 for the attachment of the membrane 22 of the pressure bulkhead 2. The surface 66 is oriented in such a way as to be locally tangential to the membrane 22. This ensures the most rectilinear possible continuity between the surface 66 and the membrane 22 in order to transfer loads coming from the membrane 22 onto the fuselage via the ring section 56 and more particularly the body 64. The flange 62 is laid on the panels 52 and 54 and attached thereto thereby joining the panels 52 and 54 together. The flange 58 of the frame 26 is fixed to the flange 62 of the ring section 56such that the web 60 of the frame extends in a direction substantially perpendicular to the flange 58 of the frame, to the flange 62 of the ring section and to the surface S tangential to the fuselage at the junction between the panels 52 and 54.

The frame 26 has a shape and configuration that follows the contours of the fuselage at a section along the line A-A shown in FIG. 2. As a result and as seen in FIG. 7, the frame 26 includes opposing lateral curved segments 55, 57 and substantially circular upper 59 and lower 61 arcs.

The membrane 22 is fixed and attached to the surface 66 of the body 64 of the ring section by suitable means such as, for example, but not limited to, bolts.

The membrane 22 comprises no system for fixing to the floor 68 of the lower deck 20 and to the floor 67 of the upper deck 18 of the fuselage 6. The integral membrane 22 can therefore function as a pure membrane. The floor 67 of the upper deck 18 is associated with the frame 26 positioned in the region of the pressure bulkhead via a transverse beam 70. In this way, the floor module comprising the transverse beam 70 can be introduced into the fuselage and quickly fixed to the frame without the need to add fixings to the pressure bulkhead.

The transverse beam 70 for the floor 67 is fixed to the conventional fixing systems 72 provided on the frames. In the embodiment illustrated in FIG. 8, the fixing systems 72 take the form of appendages or protrusions 74, 76 provided on the frame facing one another inwardly along the same transverse line. The appendages or protrusions 74, 76 are situated at the same distance away from the longitudinal plane P of symmetry of the frame 26, on each side thereof. The transverse beam 70 for the floor 67 is fixed to the appendages 74, 76 by any type of known means and, for example, but not limited to, bolts. In the embodiment illustrated, only the floor 67 of the upper deck is introduced into the fuselage in the form of an integral module. The lower floor is incorporated in the conventional way.

The very high mechanical loadings resulting from the pressure loading of the membrane 22 can be broken down chiefly in the region of the connection device 50 into forces tangential to the panels 52 and 54 and forces directed into the web 60 of the frame 26 in the direction perpendicular to the surface S. That is, the pressure loads on the membrane 22 at the attachment points will be tangential forces to the panels 52, 54, and forces to the web 60 perpendicular to the outer surface of the of the panels 52, 54.

The curvature of the substantially spherical upper half-cap 42 and lower half-cap 44 of the membrane 22 cause the frame 26 to be locally in tension and, requiring the web 60 to have a constant height in these zones. In the slightly inwardly curved portions at the elongate peripheral edges 46, 48 of the cylinder portion 32 of the membrane 22, because of the very small curvature, the web 60 of the frame 26 is loaded in bending (see FIG. 9). Because such loads carry a great penalty for the frame 26, it is necessary to adapt its geometry accordingly. Therefore, in order to improve the ability to withstand the particular bending loads at the curved elongate peripheral edges 46, 48 of the cylinder portion 32 of the membrane 22, the frame 26 has evolutive inertia. That is notably manifested in the form of embodiment illustrated by a web 60 of evolutive height. The height of the web 60 is, particularly in the embodiment illustrated, greater in the region of the lateral curve segments of the fuselage than in the upper and lower semicircular parts thereof. In FIG. 7, a line 78 indicates a frame the height of which remains identical over its entire length, in order to highlight the region in which the height of the frame is greater in the embodiment illustrated. This height makes it possible to absorb the bending loadings operating in this region as a result of the atypical shape of the cross section.

As best seen in FIGS. 7 and 9, the height of the web 60 of the frame 26 is greater in the region of the inwardly curve segments 46, 48 of the portion 32 in order to absorb bending loads in this area.

The bending loads are also absorbed by the transverse floor beam 70 which connects the appendages 74, 76 of the frame. According to the embodiment illustrated, the transverse beam 70 connects two points of the frame that have the highest inertia.

The present invention proposes a pressure bulkhead of simple shape and optimized mass the manufacture of which is simplified because it uses simple geometric shapes. Furthermore, the present invention makes it possible to take into consideration the stress loadings introduced by the modular approach.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A rear pressure bulkhead for an aircraft having an ovoid cross section with inwardly curving side walls in a tail cone region, comprising:
an integrally formed membrane having two opposing substantially spherical half-caps;
a portion of a cylinder of substantially circular cross section joining the two opposing half-caps at each end, and wherein the free elongated edges of the cylinder portion are slightly inwardly curved.

2. The rear pressure bulkhead according to claim 1, wherein each substantially spherical half-cap comprises a circular-arc edge joined to the corresponding circular-arc edge of the cylinder portion and, a free circular-arc edge of each half-cap for attaching the membrane to the aircraft.

3. An aircraft comprising a pressure bulkhead according to claim 1, wherein the cross section of the tail cone in the region of the pressure bulkhead is of the ovoid type with inwardly curved side walls, wherein the aircraft comprises a frame in the region of which the membrane is incorporated, of which the shape exhibits evolutive inertia.

4. The aircraft according to claim 3, wherein the frame comprises a web, wherein the height of the web of the frame is a height that is greater in the region of the lateral curve segments facing the edge of the membrane in the region of the cylinder portion than in the region of the upper and lower semicircular portions thereof.

5. The aircraft according to claim 4, wherein the frame comprises appendages arranged on either side thereof, on one and the same transverse line in the region of the lateral curve segments facing the edge of the membrane in the region of the cylinder portion.

6. The aircraft according to claim 5, wherein the membrane is fixed to a ring section itself fixed both to the fuselage and to the frame.

7. The aircraft according to claim 6, further comprising a transverse beam connecting the lateral curve segments of the frame.

8. The aircraft according to claim 7, wherein the transverse beam is a transverse floor beam.

9. The aircraft according to claim 8, wherein the transverse beam connects together two points of the frame that have the greatest inertia on each side of the longitudinal plane P of symmetry.

10. The aircraft according to claim 7, wherein the transverse beam connects the appendages.

11. A rear pressure bulkhead for an aircraft, comprising:
a membrane having an upper partial spherical concave portion, a lower partial spherical concave portion, and an elongate partial cylindrical portion;
the elongate partial cylindrical portion includes inwardly curved elongate side edges along a length thereof forming an ovoid cross section;
the upper partial spherical concave portion is attached along a peripheral edge thereof to a peripheral edge at one end of the elongate partial cylindrical portion and the lower partial spherical concave portion is attached along a peripheral edge thereof to a second peripheral edge of the cylindrical portion opposing the first peripheral edge.

12. An aircraft, comprising:
a tail cone section having an ovoid configuration with inwardly curved side walls;
a rear pressure bulkhead having a membrane having an upper partial spherical concave portion, a lower partial spherical concave portion, and an elongate partial cylindrical portion;
the elongate partial cylindrical portion includes inwardly curved elongate side edges along a length thereof forming an ovoid cross section;
the upper partial spherical concave portion is attached along a peripheral edge thereof to a peripheral edge at one end of the elongate partial cylindrical portion and the lower partial spherical concave portion is attached along a peripheral edge thereof to a second peripheral edge of the cylindrical portion opposing the first peripheral edge; and,
a frame having an ovoid cross sectional shape and configuration substantially conforming to the shape of the ovoid tail cone section for attaching the rear pressure bulkhead to the tail cone of the aircraft.

13. The aircraft according to claim 12, wherein the frame comprises a flange, a web substantially perpendicular to the flange and having a height greater in a middle portion thereof where the inwardly curved elongate side edge than a height in an upper and lower portions where the first and second partial spherical concave portions are attached.

14. The aircraft according to claim 13, wherein the frame further comprises a pair of protrusions on the inner middle portion thereof facing one another, wherein the protrusions are configured to support a transverse aircraft cabin floor beam.
